(19) United States
(12) Patent Application Publication
(10) Pub. No.: US 2012/0316478 A1
(43) Pub. Date: Dec. 13, 2012

(54) MASSAGE MACHINE

(75) Inventors: Nichimu Inada, Osaka (JP); Tomoki Nagamitsu, Tottori (JP)

(73) Assignee: Family Co., Ltd., Osaka (JP)

(21) Appl. No.: 13/490,926

(22) Filed: Jun. 7, 2012

(30) Foreign Application Priority Data
Jun. 8, 2011 (JP) 2011-127834

(51) Int. Cl. A61H 15/00

(52) U.S. Cl. 601/126

(57) ABSTRACT

A massage machine includes a body supporting portion which supports a body of a person to be treated and a massage mechanism which moves inside the body supporting portion along a body height direction of the person to be treated. The body supporting portion is divided in the body height direction into a base portion and a movable portion. The body supporting portion extends and contracts when the movable portion moves relative to the base portion. The massage machine is capable of adapting to the body size of the person to be treated by changing the treatment range of the massage mechanism by extending or contracting the body supporting portion.

### CROSS-REFERENCES TO RELATED APPLICATION

This application claims priority from Japanese Patent Application Serial No. 2011-127834 filed Jun. 8, 2011, the contents of which are incorporated herein by reference in its entirety.

### BACKGROUND

The present invention relates to a massage machine capable of performing satisfactory massage to suit the physique of a person to be treated by extending and contracting divided body supporting portions.

A massage machine is known, which is capable of performing optimal massage on the shoulders of a person to be treated by moving a backrest portion to suit the height of the shoulders of the person to be treated (see Japanese Unexamined Patent Application Publication No. 11-123218, for example).

However, in the massage machine disclosed by JP 11-123218, the entire seat back itself moves in the vertical direction, while and the length of the seat back itself is not variable. Therefore, the treatment range of a treatment unit does not vary. Therefore, since the treatment unit moves away from the lower back of the person to be treated as the seat back is moved upward to suit the height of the shoulders of the person to be treated, it is not possible to perform sufficient massage on the lower back.

Thus, the present invention has been made in order to solve the aforementioned problem, and an object thereof is to provide a massage machine capable of performing satisfactory massage to suit the body height of a person to be treated by changing a treatment range of a massage mechanism with extension and contraction of divided body supporting portions.

### BRIEF SUMMARY OF THE INVENTION

According to the present invention, there is provided a massage machine including: a body supporting portion which supports a body of a person to be treated; and a massage mechanism which moves inside the body supporting portion along a body height direction of the person to be treated, wherein the body supporting portion is divided in the body height direction of the person to be treated and is configured at least by a base portion and a movable portion, and wherein the body supporting portion extends and contracts when the movable portion moves relative to the base portion. With such a configuration, it is possible to perform massage to suit the body height of the person to be treated, cause the body supporting portion to contract, and downsize the body supporting portion when not used.

In addition, it is preferable that the base portion include base guide rails which guide movement of the massage mechanism, that the movable portion include movable guide rails which guide the movement of the massage mechanism, and that the movable portion move relative to the base portion when the movable guide rails slide relative to the base guide rails. With such a configuration, it is possible to change the movement stroke itself of the massage mechanism and perform massage within a treatment range to suit the body height of the person to be treated.

In addition, it is preferable that the massage mechanism include rollers which roll along the guide rails and pinions which are provided on the side of the base guide rails a predetermined distance from the rollers in the body height direction, that the base guide rails include a rack into which the pinions are fitted, and that the distance by which the movable guide rails slide relative to the base guide rails be within the predetermined distance. With such a configuration, it is not necessary to provide a rack on the side of the movable guide rails, and therefore, it is possible to manufacture the massage machine at low cost. In addition, the pinions of the massage mechanism are not released from the rack, and it is possible to enhance safety.

In addition, it is preferable that a locking mechanism which fixes the base portion and the movable portion be further provided. With such a configuration, it is possible to enhance safety.

In addition, it is preferable that the movable portion be provided with handles which are for sliding the movable portion. With such a configuration, it is possible to cause the movable guide rails to easily slide relative to the base guide rails.

In addition, it is preferable that a braking means when moving be provided in at least one of the base portion and the movable portion. With such a configuration, it is possible to enhance safety. Particularly, it is possible to prevent the movable portion from rapidly moving due to its own weight during contraction of the body supporting portion.

In addition, it is preferable that the body supporting portion be provided with a cover member which covers the massage mechanism, and that the cover member be configured so as to be able to extend and contract in accordance with extension and contraction of the body supporting portion. With such a configuration, it is possible to cause the cover member to follow the extension and the contraction of the body supporting portion.

In addition, it is preferable that an extension and contraction driving unit which drives the body supporting portion to extend and contract be further provided, and that the body supporting portion be made to extend and contract by moving the movable portion relative to the base portion with the use of driving force of the extension and contraction driving unit. With such a configuration, it is possible to cause the movable portion to slide in an automatic manner instead of a manual manner.

### BRIEF DESCRIPTION OF THE DRAWINGS

FIG. 1 is a perspective view of a massage machine in a standing position.

FIG. 2 is a block diagram showing a configuration of a massage machine according to a first embodiment.

FIG. 3 is a perspective view of an appearance of a body supporting portion (backrest portion) according to the first embodiment when viewed from a front and obliquely upper direction.

FIG. 4 is a diagram of a massage mechanism when viewed from a front direction.

FIG. 5 is a diagram of the massage mechanism when viewed from a back direction.

FIG. 6 is a perspective view of an appearance of a partial configuration of the backrest portion (body supporting portion) according to the first embodiment when viewed from the front and obliquely upper direction, which shows the longest state of the backrest portion.

FIG. 7 is a perspective view of an appearance of a partial configuration of the backrest portion (body supporting portion) according to the first embodiment when viewed from the front and obliquely upper direction, which shows a shortest state of the backrest portion.

FIG. 8 is a perspective view of an appearance of a locking mechanism when viewed from the front and obliquely upper direction.

FIG. 9 is a diagram of a partial configuration of the locking mechanism when viewed from a left side.

FIG. 10 is an explanatory operation diagram for a sliding operation of a locking mechanism.

FIG. 11 is a diagram of a partial configuration of a braking means by a compression spring when viewed from a left side.

FIG. 12 is an explanatory operation diagram for extension and contraction operations of a cover member.

FIG. 13 is a perspective view of an appearance of a partial configuration of a backrest portion (body supporting portion) according to a second embodiment when viewed from a front and obliquely upper direction, which shows the longest state of the backrest portion.

FIG. 14 is a perspective view of an appearance of a partial configuration of the backrest portion (body supporting portion) according to the second embodiment when viewed from the front and obliquely upper direction, which shows the shortest state of the backrest portion.

FIG. 15 is a block diagram showing a configuration of a massage machine according to the second embodiment.

FIG. 16 is an explanatory operation diagram for extension and compression operation of a footrest.

### DETAILED DESCRIPTION

### First Embodiment

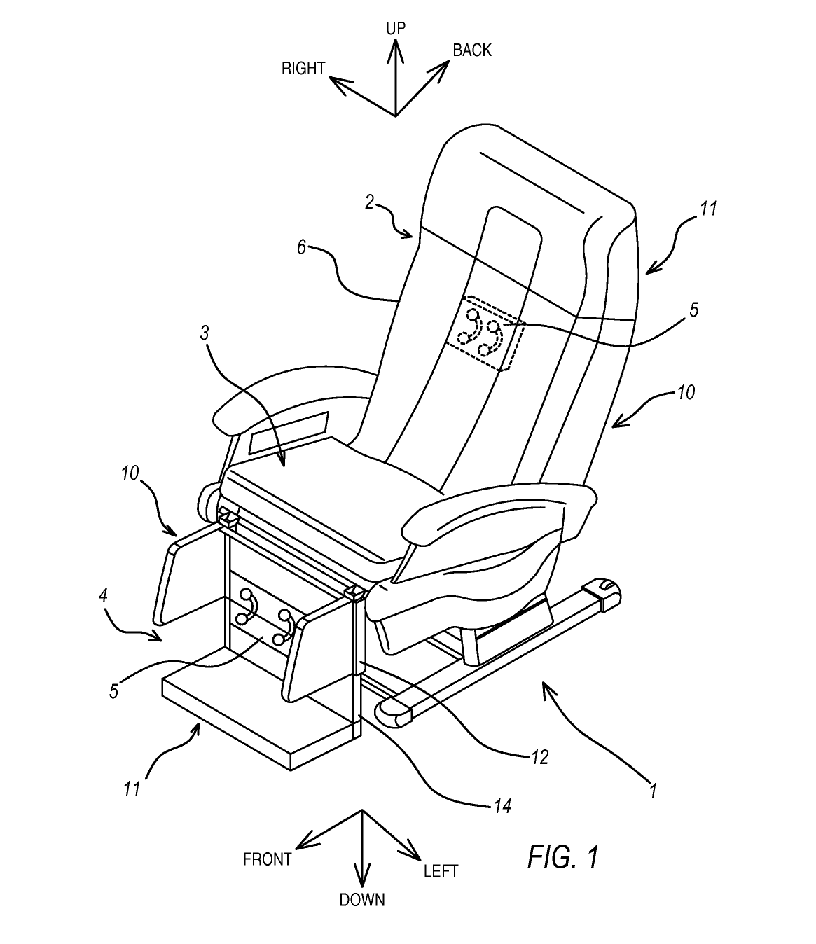

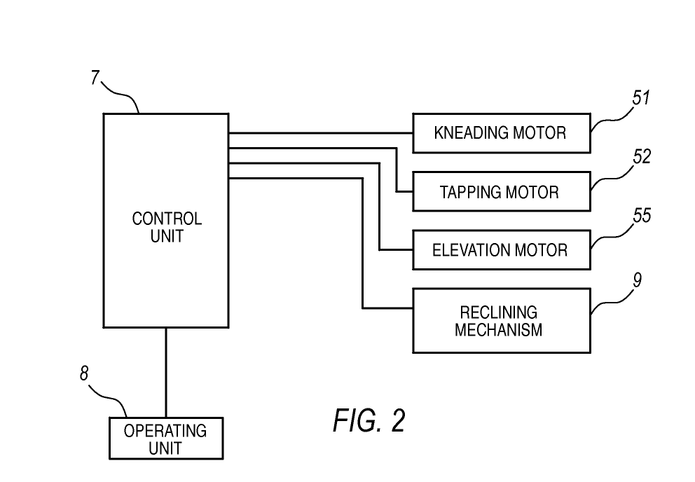

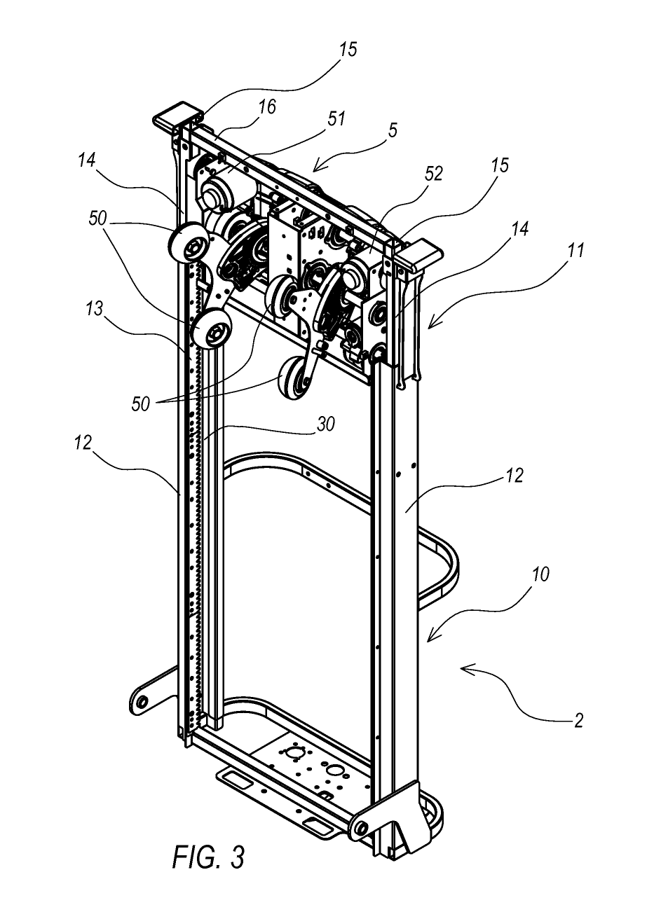

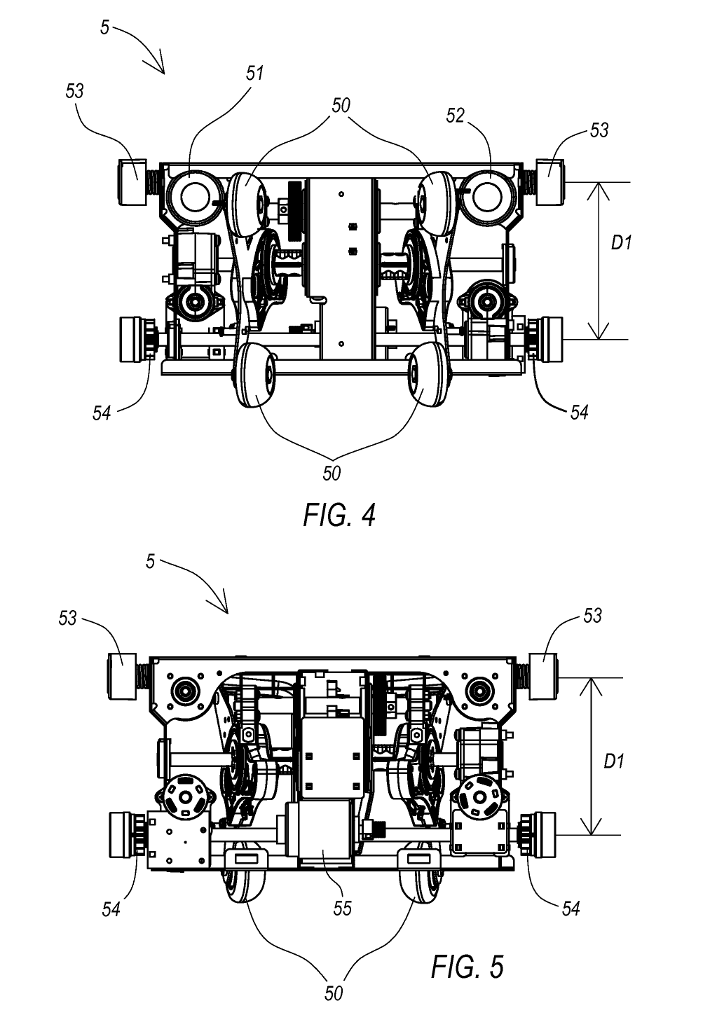

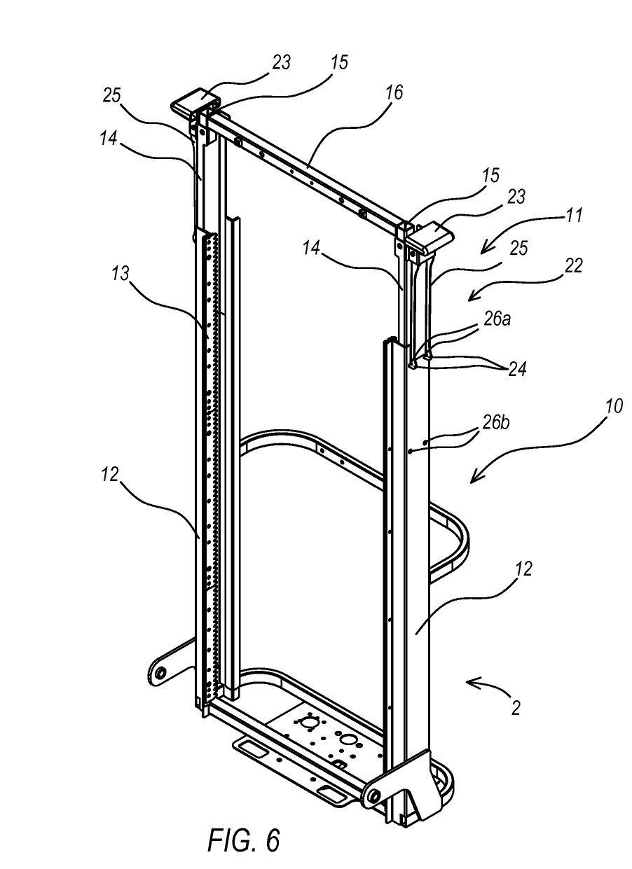

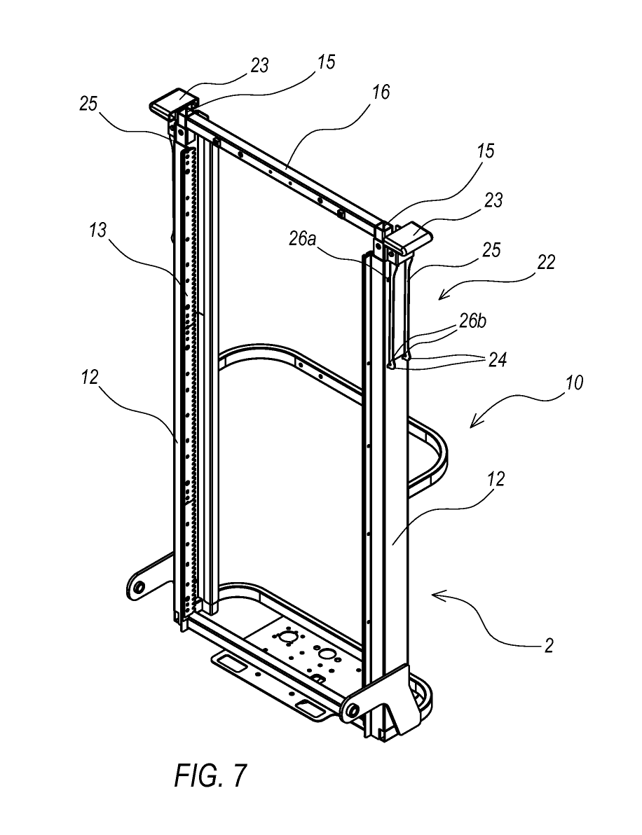

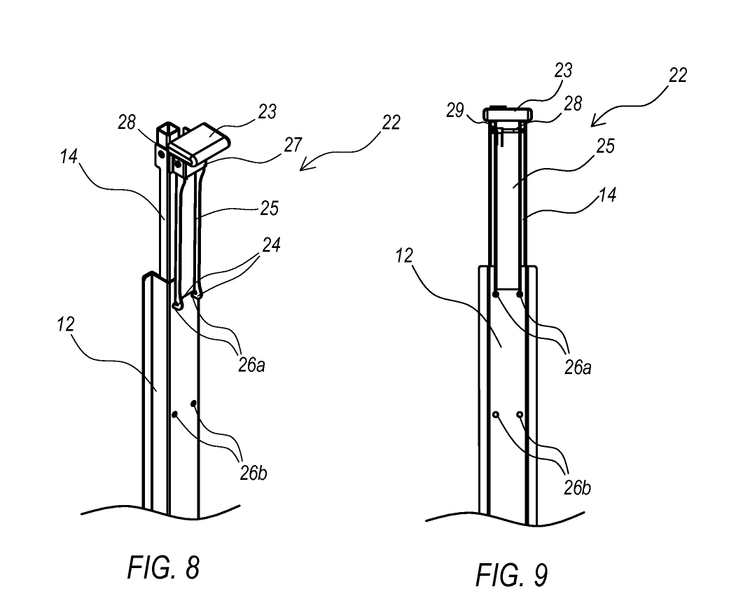

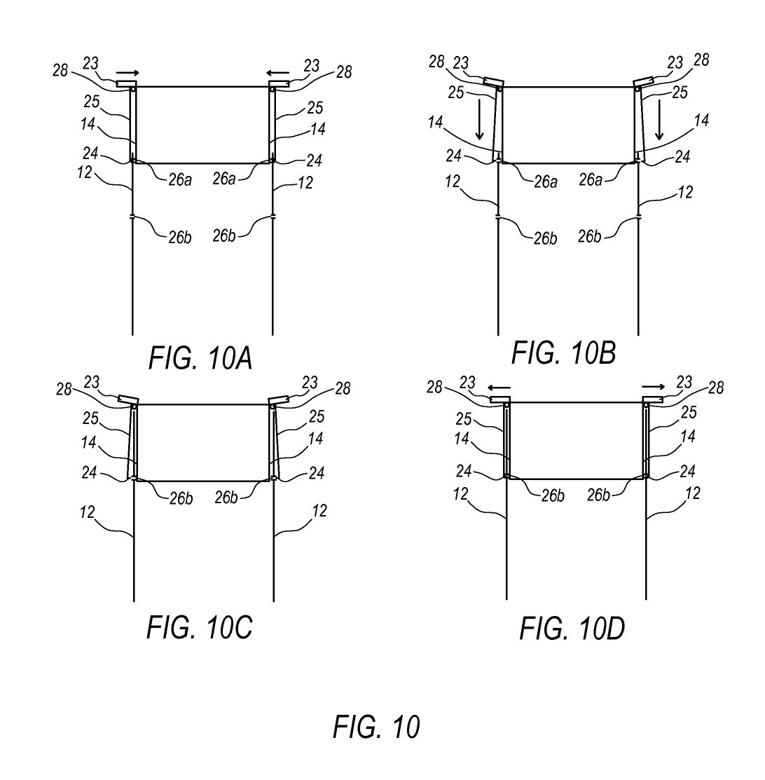

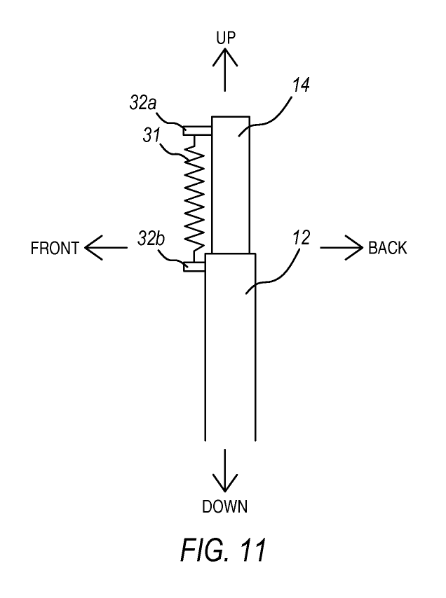

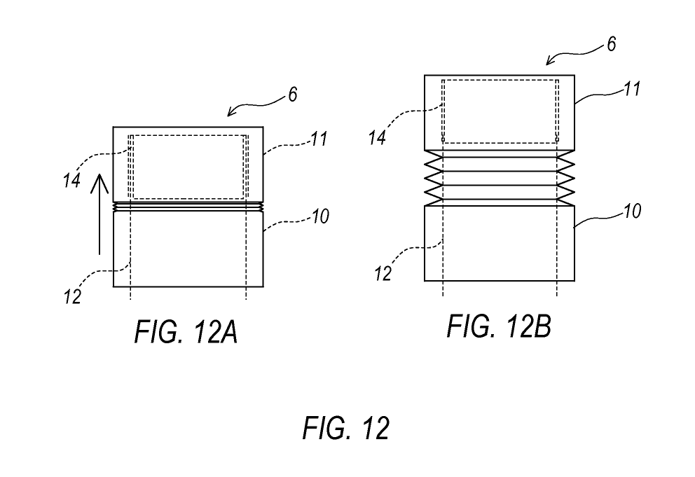

Hereinafter, description will be given of a configuration of a massage machine 1 according to a first embodiment of the present invention. FIG. 1 is a perspective view of the massage machine 1 according to a first embodiment in a front position state, FIG. 2 is a block diagram showing a configuration of the massage machine 1 according to the first embodiment, FIG. 3 is a perspective view of an appearance of a backrest portion 2 as a body supporting portion according to the first embodiment when viewed from a front and obliquely upper direction, FIG. 4 is a diagram of a massage mechanism 5 when viewed from a front direction, FIG. 5 is a diagram of the massage mechanism 5 when viewed from a back direction, FIG. 6 is a perspective view of an appearance of a partial configuration of the backrest portion 2 (body supporting portion) according to the first embodiment when viewed from the front and obliquely upper direction, which shows the backrest portion 2 in the longest state, FIG. 7 is a perspective view of an appearance of a partial configuration of the backrest portion 2 (body supporting portion) according to the first embodiment when viewed from the front and obliquely upper direction, which shows the backrest portion in the shortest state, FIG. 8 is a perspective view an appearance of a locking mechanism 22 when viewed from the front and obliquely upper direction, FIG. 9 is a diagram of a partial configuration of the locking mechanism 22 when viewed from a left side, FIG. 10 is an explanatory operation diagram for a sliding operation of a locking mechanism 22, FIG. 11 is a diagram of a partial configuration of a braking means by a compression spring 31 when viewed from the left side, and FIG. 12 is an explanatory operation diagram for extension and compression operations of a cover member 6.

### Overall Configuration

As shown in FIG. 1, the massage machine 1 according to the first embodiment of the present invention mainly includes a backrest portion 2, a seat portion 3, and a footrest 4, which together are a body supporting portion that supports a body of a person to be treated; a massage mechanism 5, which performs massage on a part to be treated by moving within the body supporting portion (the backrest portion 2 and the footrest portion 4) along a body height direction of the person to be treated; and a cover member 6, which covers the massage mechanism 5. In addition, as shown in FIG. 2, the massage machine 1 includes a control unit 7 which controls drive and stop of the massage mechanism 5 and an operation unit 8 which sends a command to the control unit 7. In addition, it is preferable that the backrest portion 2 be supported by a seat portion 3 so as to be able to recline and that a reclining mechanism 9 for changing a reclining angle of the backrest portion 2 be provided between the seat portion 3 and the backrest portion 2. The reclining mechanism 9 is provided with an actuator (not shown) which is driven by an electric motor, for example, to extend and contract, and the backrest portion 2 is brought to be in a standing state when the actuator extends while the backrest portion 2 is brought to be in a lying-down state when the actuator contracts.

In addition, directional concepts used in the following description are the same as those viewed from the person to be treated who is seated on the massage machine 1 of the present invention. That is, the front side, the back side, the left-hand side, and the right-hand side viewed from the person to be treated who is seated on the massage machine 1 are referred to as “front”, “back”, “left”, and “right” sides, respectively, and the body height direction of the person to be treated is referred to as a vertical direction (the side of the head corresponds to an “upper” side, and the side of the lower back corresponds to a “lower” side).

### Configuration of Body Supporting Portion

Hereinafter, description will be given of a configuration of the backrest portion 2 as a representative of a configuration of the body supporting portion. As shown in FIGS. 1 and 3, the backrest portion 2 includes a base portion 10 and a movable portion 11 and is configured to be divided in the vertical direction.

The base portion 10 is provided with base guide rails 12 on both the left and right ends and is configured to guide the movement of the massage mechanism 5. The base guide rails 12 have a substantially U-shaped cross section and are positioned such that their open surfaces face each other. The base guide rails 12 each include a rack 13 at an inner edge. A pair of pinions 54 included in the massage mechanism 5 (described later), is fitted into the racks 13 so as to be able to move up and down. The base guide rails 12 are held by the base portion 10, and the massage mechanism 5 can move up and down within the base portion 10 to suit a part to be treated.

In addition, the movable portion 11 is provided with movable guide rails 14 on both the left and right ends, which are configured to guide the movement of the massage mechanism 5. The movable guide rails 14 have a substantially U-shaped cross section and are positioned such that their open surfaces face with each other. Each movable guide rail 14 is provided in one of the base guide rails 12, and is configured to be able to slide with respect to the base guide rails 12.

In addition, there are provided on the upper ends of the movable guide rails 14 a pair of joint stoppers 15, which prevents the massage mechanism 5 from deviating from the base guide rails 12, and a joint pipe 16 which fixes the base guide rails 12 and the movable guide rails 14 such that the horizontal widths thereof are constant.

### Configuration of Massage Mechanism

Hereinafter, description will be given of a configuration of the massage mechanism 5 provided inside the backrest portion 2. As shown in FIGS. 3, 4, and 5, the massage mechanism 5 is provided inside the backrest portion 2 and has the configuration as described below.

The massage mechanism 5 has four treatment elements 50, which respectively have roller shapes, and these treatment elements 50 are disposed at a position that is slightly to the back of the front surface of the backrest portion 2 (the surface supporting the body of the person to be treated) and are separated from each other in vertical and horizontal directions. In addition, the massage mechanism 5 is provided with motors (a kneading motor 51, a tapping motor 52), and the treatment elements 50 are operated when the respective motors are driven such that massage including kneading, tapping, applying finger pressure, and the like is available.

In addition, the massage mechanism 5 includes rollers 53, which roll along the base guide rails 12 and the movable guide rails 14, and pinions 54, which are provided on the sides of the massage mechanism 5 that are near the base guide rails 12 a predetermined distance D1 from the roller 53.

Moreover, the movement direction of the massage mechanism 5 is guided by the base guide rails 12 and the movable guide rails 14 extending in the vertical direction inside the backrest portion 2, as described above, so as to be movable in the vertical direction within the backrest portion 2 when the pinions 54 are fitted into the rack 13 included in the base guide rails 12 and the pinions 54 are rotated by the drive of the elevation motor 55 provided in the massage mechanism 5.

### Configuration of Sliding Mechanism

As described above, the movable guide rails 14 are configured to be slidable with respect to the base guide rails 12 within the predetermined distance D1 between the rollers 53 and the pinions 54 which are provided in the massage mechanism 5.

That is, a state in which the entire movable guide rails 14 are within the base guide rails 12 corresponds to a shortest state of the backrest portion 2 (see FIG. 7), and a state in which the pinions 54 are fitted into the upper ends of the rack 13 of the base guide rails 12 corresponds to a longest state of the backrest portion 2 (see FIGS. 3 and 6).

Accordingly, a range in which the backrest portion 2 can extend and contract is determined depending on the predetermined distance D1, and therefore, it is possible to set the range in which extension and contraction are possible in various manners by changing the distance between the rollers 53 and the pinions 54 in the massage mechanism 5.

### Configuration of Locking Mechanism

Hereinafter, description will be given of the locking mechanism 22 which is for fixing the base portion 10 and the movable portion 11. As shown in FIGS. 6 and 7, the locking mechanism 22, which is for fixing the base portion 10 and the movable portion 11, according to this embodiment is configured mainly by locking links 25, handles 23, each of which is provided at one end of a locking link 25, and protrusions 24, each of which is provided at the other end of the locking link 25. A locking link 25 with the handle 23 provided at one end thereof and with the protrusion 24 provided at the other end is attached to each of the outer surfaces of the pair of movable guide rails 14, and it is possible to fix and lock the movable guide rails 14 with respect to the base guide rails 12 by fitting the protrusions 24 into holes 26a and 26b provided in the movable guide rails 14.

Moreover, FIG. 8 is a diagram of the locking mechanism 22 when viewed from the front and obliquely upper direction, in which a locking supporting point bracket 27 which supports the locking link 25 is attached to the end of the outer surface of the movable guide rail 14 and the locking link 25 is pivotally supported with respect to the movable guide rail 14 with a supporting pin 28 penetrating the locking supporting point bracket 27 and the lock link 25 in the front-back direction.

In addition, FIG. 9 is a diagram of the locking mechanism 22 without the locking supporting point brackets 27 when viewed from the left side, in which a torsion coil spring 29 is wound around the supporting pin 28, one end of the torsion coil spring 29 abuts on the locking supporting point bracket 27 while the other end thereof abuts on the locking link 25, and the protrusion 24 included in the locking link 25 is biased in a direction in which the protrusion 24 is fitted into the hole 26a.

FIG. 10 is an explanatory diagram for a series of operations by which the backrest portion 2 is made to slide with the use of the locking mechanism 22, where (a) is a diagram schematically showing the backrest portion 2 in the longest state when viewed from the front side, (b) shows a state in which the locking mechanism 22 is released from the state in (a), (c) is a diagram schematically showing the backrest portion 2 in the shortest state when viewed from the front side, and (d) shows a state in which the movable guide rails 14 are locked to the base guide rails 12 from the state of (c), respectively.

As shown in FIGS. 10(a) and 10(b), if the pair of handles 23 is simultaneously biased toward the side of the movable guide rails (i.e., in an inward/upper direction) then the locking links 25 are rotated about the supporting pins 28 in a direction in which the locking links 25 are separated from the movable guide rails 14 (i.e., to the horizontally outside), and the protrusions 24 of the locking links 25 are released from the holes 26a. In so doing, the movable guide rails 14 are unlocked so as to be able to slide with respect to the base guide rails 12 as shown in FIG. 10(c).

In addition, when the biasing of the pair of handles 23 toward the side of the movable guide rails is ceased, the locking links 25 are rotated about the supporting pins 28 to the side of the movable guide rails (i.e., to the horizontally inside) such that the protrusions 24 of the locking links 25 are fitted into the holes 26b. In so doing, it is possible to fix and lock the movable guide rails 14 with respect to the base guide rails 12, as shown in FIG. 10(d).

In FIGS. 6 and 7, the holes 26a and 26b opened in the base guide rails 12 are provided at positions in the state in which the entire movable guide rails 14 are in the base guide rails 12 (the shortest state of the backrest portion) and at positions in the state in which the pinions 54 are fitted into the upper ends of the rack 13 of the base guide rails 12 (the longest state of the backrest portion) so as to configure a two-stage locking mechanism. However, multiple holes may be provided at intermediate positions in the base guide rails 12 so as to configure a multi-stage locking mechanism.

### Configuration of Braking Means

Hereinafter, description will be given of the braking means when the base portion 10 and the movable portion 11 move, based on FIGS. 3 and 11. The massage machine 1 is provided with the braking means for the movement of the movable portion 11 relative to the base portion 10 of the backrest portion 2.

As the braking means, it is possible to use a brake employing sliding friction of rubber pads 30 and a brake using biasing force of the compression springs 31.

When the braking means comprises the rubber pads 30, the rubber pads 30 may be fixed to the outer surface of the movable guide rails 14 or the inner surface of the base guide rails 12, and appropriate braking may be accomplished during sliding by friction between the rubber pads 30 and the movable guide rails 14 or the base guide rails 12. FIG. 3 shows a state in which the rubber pads 30 are fixed to the inner surfaces of the base guide rails 12.

Alternatively, when the braking means comprises the biasing force of the compression springs 31, one end of the compression spring 31 is attached to a bracket 32a provided in the movable guide rail 14, and the other end is attached to a bracket 32b provided in the base guide rail 12, as shown in FIG. 11, so as to obtain a state in which the backrest portion is always biased to a direction in which the backrest portion 2 is extended. The force of the compression spring 31 may be set to a magnitude that allows the compression spring 31 to be easily contracted with the force of a human hand, and appropriate braking may be accomplished while the movable guide rails 14 slide relative to the base guide rails 12 by the biasing force of such compression springs 31.

### Configuration of Cover Member

Hereinafter, description will be given of the cover member 6 which covers the massage mechanism 5. As shown in FIG. 1, the backrest portion 2 is provided with the cover member 6 made of a flexible fabric or the like in order to cover the massage mechanism 5, and the cover member 6 is formed to an accordion shape. FIG. 12 is an explanatory diagram of a series of operations by which the cover member 6 is extended and contracted in accordance with the extension and contraction of the backrest portion 2, where (a) is a diagram schematically showing the cover member 6 in the contraction state of the backrest portion 2 when viewed from the front side, and (b) shows the cover member 6 in the state in which the backrest portion 2 is extended from the state in (a). By forming the cover member 6 to such an accordion shape as described above, the cover member 6 can also be configured so as to be able to extend and contract in accordance with extension and contraction of the movable portion 11.

### Second Embodiment

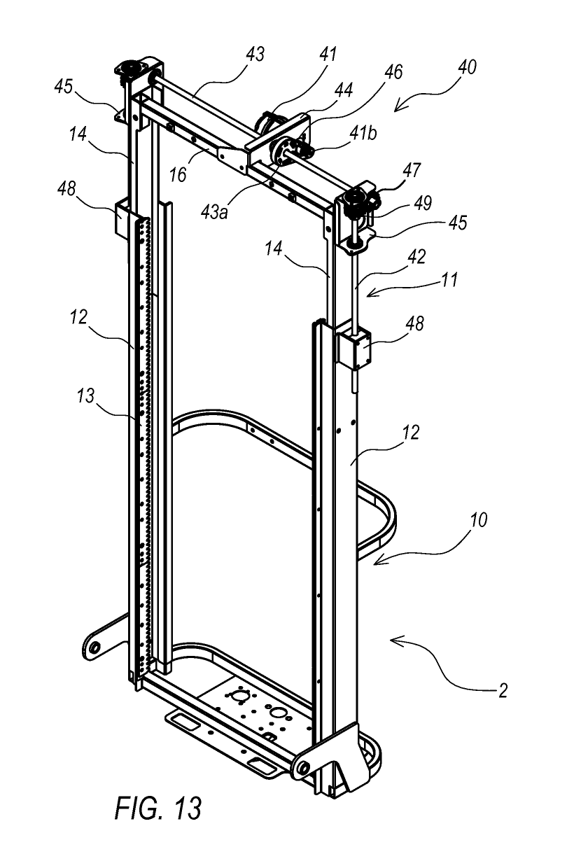

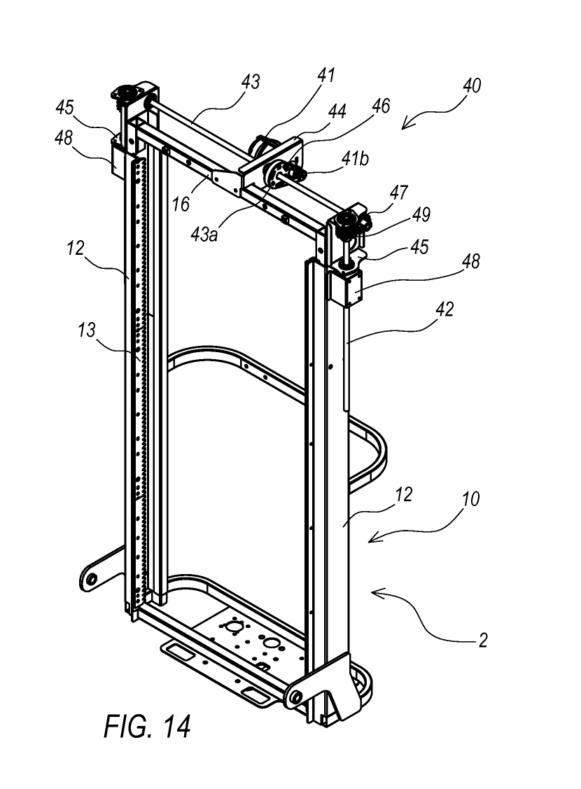

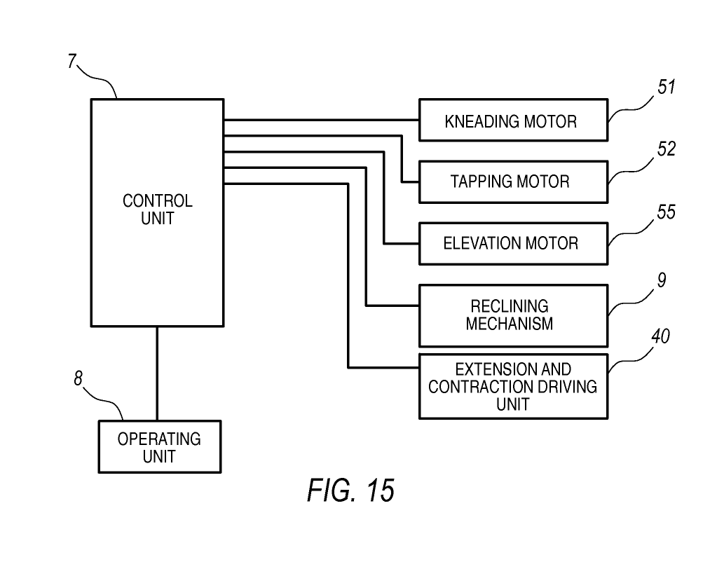

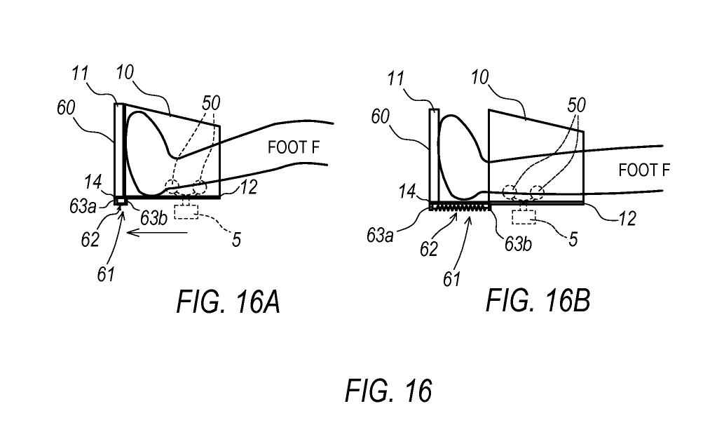

Hereinafter, description will be given of a configuration of a massage machine 1 according to a second embodiment of the present invention. FIG. 13 is a perspective view of an appearance of a partial configuration of a backrest portion 2 (body supporting portion) according to the second embodiment when viewed from the front and obliquely upper direction, which is a diagram showing the longest state of the backrest portion 2. FIG. 14 is a perspective view of an appearance of a partial configuration of the backrest portion 2 (body supporting portion) according to the second embodiment when viewed from the front and obliquely upper direction, which is a diagram showing the shortest state of the backrest portion 2. FIG. 15 is a block diagram showing the configuration of the massage machine 1 according to the second embodiment. FIG. 16 is an explanatory operation diagram for a sliding operation of the footrest 4.

The massage machine 1 according to the second embodiment is a massage machine 1 capable of extending and contracting the backrest portion 2 by moving the movable portion 11 relative to the base portion 10 using the driving force of the extension and contraction driving unit 40.

In addition, same reference numerals are given to the same configurations as those in the massage machine 1 according to the first embodiment, and the description thereof will be omitted.

### Overall Configuration

As shown in FIGS. 13 and 14, the configuration of the second embodiment is different from that of the first embodiment in that the extension and contraction driving unit 40 is provided for driving the body supporting portion to be extended and contracted, instead of the locking mechanism 22.

The extension and contraction driving unit 40 includes a driving motor 41, screw bars 42 provided along the movable guide rails 14 and the base guide rails 12, and a drive shaft 43, which delivers the driving force of the driving motor 41 to the screw bars 42. With such an extension and contraction driving unit 40, the movable guide rails 14 can move relative to the base guide rails 12 and stop at arbitrary positions.

In addition, as shown in FIG. 15, the extension and contraction driving unit 40 includes a control unit 7 which controls the driving motor 41 to be driven and stopped and an operation unit 8 through which the person to be treated gives a control command to the control unit 7. It is convenient that the operation unit 8 is provided in one remote controller along with the operation unit 8 of the massage mechanism 5.

### Description of Extension and Contraction Driving Unit

Hereinafter, description will be given of a configuration of the extension and contraction driving unit 40 provided in the massage machine 1. As shown in FIGS. 13 and 14, the extension and contraction driving unit 40 is provided with a driving motor 41 with an output shaft (not shown), which can be rotated in normal and inverse directions. The driving motor is fixed to a motor bracket 44, which is fixed to a joint pipe 16. The extension and contraction driving unit 40 is also provided with a driving shaft 43, which extends in a horizontal direction and is attached to contraction and expansion driving brackets 45 provided at the upper ends of the outer surfaces of the movable guide rails 14. A pulley 43a is coaxially attached to the driving shaft 43, and the pulley 43a and a pulley 41b that is coaxially attached to the output shaft of the driving motor 41 are coupled to each other with a belt 46.

Accordingly, rotational movement of the output shaft of the driving motor 41 is delivered to the driving shaft 43 via the belt 46, and worm gears 47 provided at both ends of the driving shaft 43 are rotated. In addition, one end of each screw bar 42 is screwed into a nut 48 attached to the outer side of the base guide rail 12 so as to penetrate the nut 48 in the vertical direction, and the other end thereof is fixed to the extension and contraction driving bracket 45. In addition, a worm 49 is provided at the other end of each screw bar 42 so as to engage with the worm gear 47 provided at each of both ends of the driving shaft 43.

Accordingly, the rotation is delivered from the worm gears 47 to the worms 49 when the output shaft of the driving motor 41 is rotated, the screw bars 42 are rotated thereby, and thus, the movable guide rails 14 can slide relative to the base guide rails 12 in the vertical direction.

### Configuration of Reclining Interlocking Mechanism

Hereinafter, description will be given of a configuration of an interlocking mechanism of the reclining mechanism 9 and the extension and contraction driving unit 40 according to the second embodiment.

As described above, the massage machine 1 is provided with the reclining mechanism 9, and a range in which the body of the person to be treated abuts on the backrest portion 2 (body abutting range) becomes different before and after the reclining since the body of the person to be treated is deviated downward when the backrest portion 2 is reclined.

That is, the body abutting range before the reclining of the backrest portion 2 is narrower than that after the reclining.

Accordingly, it is preferable that the control unit 7 control the extension and contraction driving unit 40 so as to adjust the extension and contraction range of the backrest portion 2 in accordance with such a body abutting ranges before and after the reclining of the backrest portion 2. Specifically, the control unit 7 controls the extension and contraction driving unit 40 to cause the movable portion 11 to slide and move downward with respect to the base portion 10 so as to contract the backrest portion 2 in response to the reclining of the backrest portion 2 and to cause the movable portion 11 to slide and move upward with respect to the base portion 10 so as to extend the backrest portion 2 in response to the standing operation of the backrest portion 2.

### Configuration of Footrest Extension and Contraction Mechanism

Hereinafter, description will be give of an extension and contraction mechanism in the footrest 4. The footrest 4 has the same configuration as that in the backrest portion 2, in which the footrest 4 extends and contracts when the movable portion 11 moves relative to the base portion 10. The footrest 4 may be configured to include a locking mechanism 22 as described with respect to the backrest portion 2 in the first embodiment. The footrest 4 may alternatively be configured to include an extension and contraction driving unit 40 as described with respect to the backrest portion 2 in the second embodiment. The configuration of the footrest 4 having a locking mechanism 22 or an extension and contraction driving unit 40 is identical to the respective configurations of the backrest portion 2 described above (although the actual dimensions of each may differ), with the exception that the movable portion 11 of the footrest 4 is located at the lower end of the footrest 4 (rather than the upper end, as in the backrest portion 2), and therefore components positioned at an upper end of other components in the backrest portion 2 will be positioned at a lower end of the respective components in the footrest 4, and visa-versa.

FIG. 16 is an explanatory operation diagram for extension and contraction operations of the footrest 4, where (a) is a diagram schematically showing the footrest 4 in the shortest state when viewed from the left side, and (b) shows a state in which the footrest 4 is extended from the state in (a).

When the base portion 10 of the footrest 4 is provided with a sole retaining portion 60, a configuration is also applicable in which a spring extension and contraction mechanism 61 is provided in the footrest 4 instead of the locking mechanism 22 and the extension and contraction driving unit 40 and the footrest 4 is made to extend and contract by causing the movable portion 11 to move relative to the base portion 10 when the person to be treated places the soles of their feet onto the sole retaining portion 60.

When the spring extension and contraction mechanism 61 is used, one end of the spring 62 is attached to the bracket 63a provided in the movable guide rail 14, and the other end is attached to the bracket 63b provided in the base guide rail 12, as shown in FIG. 16, so as to obtain a state in which the footrest 4 is always biased to the direction in which the footrest 4 is contracted. The biasing force of the spring 62 is set to a magnitude that allows the spring 62 to be easily extended with the force of a human foot, and in this case, it is not necessary to provide the braking means for the movement of the movable portion 11 relative to the base portion 10.

When the person to be treated is seated on the main body of the massage machine 1, places the foot F in the footrest 4, and causes the soles to abut on the sole retaining portion 60, as shown in FIG. 16(a), and then extends the foot F against the biasing force of the spring 62 as shown in FIG. 16(b), the movable guide rails 14 slide relative to the base guide rails 12 in a direction in which the footrest 4 extends. In so doing, it is possible to extend and contract the footrest 4 by moving the movable portion 11 relative to the base portion 10.

The preceding description has been presented only to illustrate and describe exemplary embodiments of the massage machine. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope.

1. A massage machine comprising:
a body supporting portion configured to support the body of a person to be treated; and
a massage mechanism that moves inside the body supporting portion along a body height direction,
wherein the body supporting portion is divided in the body height direction into at least a base portion and a movable portion, and
wherein the movable portion is configured to move relative to the base portion and the body supporting portion extends and contracts when the movable portion moves relative to the base portion.

2. The massage machine according to claim 1,
wherein the base portion includes base guide rails configured to guide the movement of the massage mechanism,
wherein the movable portion includes movable guide rails configured to guide the movement of the massage mechanism, and
wherein the movable portion moves relative to the base portion when the movable guide rails slide relative to the base guide rails.

3. The massage machine according to claim 2,
wherein the massage mechanism includes rollers that roll along the guide rails and pinions that are provided a predetermined distance from the rollers in the body height direction,
wherein the base guide rails include a rack into which the pinions are fitted, and
wherein the distance by which the movable guide rails slide relative to the base guide rails is within the predetermined distance.

4. The massage machine according to claim 3,
wherein the body supporting portion comprises a backrest portion and a footrest portion,
wherein the massage mechanism is located within backrest portion and a second massage mechanism is located within the footrest portion, and
wherein both the backrest portion and the footrest portion comprise a base portion and a moveable portion and are configured to extend and contract when their respective movable portions move relative to their respective base portions.

5. The massage machine according to claim 1, further comprising:
a locking mechanism which fixes the base portion and the movable portion.

6. The massage machine according to claim 1,
wherein the movable portion is provided with handles which are for sliding the movable portion.

7. The massage machine according to claim 1,
wherein braking means for a case of moving is provided in at least one of the base portion and the movable portion.

8. The massage machine according to claim 1,
wherein the body supporting portion is provided with a cover member which covers the massage mechanism, and
wherein the cover member is configured so as to be able to extend and contract in accordance with extension and contraction of the body supporting portion.

9. The massage machine according to claim 1, further comprising:
an extension and contraction driving unit configured to drive the body supporting portion to extend and contract,
wherein the body supporting portion is made to extend and contract by moving the movable portion relative to the base portion with the use of driving force of the extension and contraction driving unit.

10. The massage machine according to claim 2, further comprising:
a locking mechanism which fixes the base portion and the movable portion.

11. The massage machine according to claim 2,
wherein the movable portion is provided with handles which are for sliding the movable portion.

12. The massage machine according to claim 2,
wherein braking means for a case of moving is provided in at least one of the base portion and the movable portion.

13. The massage machine according to claim 2,
wherein the body supporting portion is provided with a cover member which covers the massage mechanism, and
wherein the cover member is configured so as to be able to extend and contract in accordance with extension and contraction of the body supporting portion.

14. The massage machine according to claim 2, further comprising:
an extension and contraction driving unit configured to drive the body supporting portion to extend and contract,
wherein the body supporting portion is made to extend and contract by moving the movable portion relative to the base portion with the use of driving force of the extension and contraction driving unit.

15. The massage machine according to claim 3, further comprising:
a locking mechanism which fixes the base portion and the movable portion.

16. The massage machine according to claim 3,
wherein the movable portion is provided with handles which are for sliding the movable portion.

17. The massage machine according to claim 3,
wherein braking means for a case of moving is provided in at least one of the base portion and the movable portion.

18. The massage machine according to claim 3,
wherein the body supporting portion is provided with a cover member which covers the massage mechanism, and
wherein the cover member is configured so as to be able to extend and contract in accordance with extension and contraction of the body supporting portion.

19. The massage machine according to claim 3, further comprising:
an extension and contraction driving unit configured to drive the body supporting portion to extend and contract,
wherein the body supporting portion is made to extend and contract by moving the movable portion relative to the base portion with the use of driving force of the extension and contraction driving unit.
